(19) United States
(12) Patent Application Publication
(10) Pub. No.: US 2026/0230230 A1
(43) Pub. Date: Aug. 6, 2026

(54) TRANSMISSION SYSTEM, TRANSMISSION DEVICE, AND TRANSMISSION METHOD

(71) Applicant: Sony Semiconductor Solutions Corporation, Kanagawa (JP)

(72) Inventor: Tetsuya Hiraoka, Kanagawa (JP)

(21) Appl. No.: 19/148,181

(22) PCT Filed: Feb. 20, 2024
(86) PCT No.: PCT/JP2024/005922

§ 371 Date: Jul. 15, 2025

(30) Foreign Application Priority Data
Mar. 6, 2023 (JP) 2023-033701

(51) Int. Cl. H04L 1/1809; H04L 1/00; H04L 1/1607; H04L 1/1867

(52) U.S. Cl. CPC H04L 1/1809; H04L 1/0045; H04L 1/0061; H04L 1/1642; H04L 1/1867

(57) ABSTRACT

Packet transmission with error notification is disclosed. In one example, a transmission system includes a first transmission device and a second transmission device connected via an A-PHY I/F. The first transmission device includes a first transmission unit that, in a case where an error in an A-packet transmitted from the second transmission device is detected, generates and transmits error notification data to which an MC number of an error packet is added. The second transmission device includes a second transmission unit that holds correspondence information in which a type of the A-packet is associated with the MC number, in a case where the error notification data transmitted from the first transmission device is received, acquires a type of the A-packet corresponding to the MC number of the error packet added to the error notification data from the correspondence information, and restores a type of the error packet.

### TECHNICAL FIELD

The present disclosure relates to a transmission system, a transmission device, and a transmission method, and more particularly, to a transmission system, a transmission device, and a transmission method capable of making a notification of a packet error more appropriately.

### BACKGROUND ART

One of the standards defined by the mobile industry processor interface (MIPI) alliance is the automotive PHY (A-PHY) standard (see, for example, Non-Patent Document 1). The A-PHY is a standard related to a PHY layer of serializer/deserializer (SerDes) for in-vehicle use. In an A-PHY network, an A-packet (A-Packet) is used.

### CITATION LIST

### Non-Patent Document

Non-Patent Document 1: MIPI Alliance Specification for A-PHY, version 1.1, MIPI Alliance, Inc., 9 Aug. 2021.

### SUMMARY OF THE INVENTION

### Problems to Be Solved by the Invention

In a current scheme, in a case where an error occurs in an A-packet being transmitted, a reception side notifies a transmission side of the packet error according to determination performed by an upper layer. Thus, there is a problem that it takes time to process the packet error, and a new scheme has been desired to be proposed for notification of a packet error.

The present disclosure has been made in view of such circumstances, and is to, in a case where an error occurs in a packet, enable more appropriate notification of the packet error.

### Solutions to Problems

A transmission system according to one aspect of the present disclosure is a transmission system including a first transmission device and a second transmission device connected via an A-PHY I/F defined in an MIPI standard, in which the first transmission device includes a first transmission unit that, in a case where an error in an A-packet transmitted from the second transmission device is detected, generates error notification data to which an MC number of an error packet that is the A-packet in which the error has been detected is added, and transmits the generated error notification data to the second transmission device, the second transmission device includes a second transmission unit that holds correspondence information in which a type of the transmitted A-packet is associated with an MC number of the A-packet, and in a case where the error notification data transmitted from the first transmission device is received, acquires from the held correspondence information a type of the A-packet corresponding to the MC number of the error packet added to the received error notification data and restores a type of the error packet, and the first transmission unit and the second transmission unit perform processing related to A-PHY.

In the transmission system according to one aspect of the present disclosure, the first transmission device and the second transmission device are connected via the A-PHY I/F defined in the MIPI standard, in a case where an error in an A-packet transmitted from the second transmission device is detected, the first transmission unit of the first transmission device generates error notification data to which an MC number of an error packet that is the A-packet in which the error has been detected is added, and transmits the generated error notification data to the second transmission device, and the second transmission unit of the second transmission device holds correspondence information in which the type of the transmitted A-packet is associated with the MC number of the A-packet, and in a case where the error notification data transmitted from the first transmission device is received, acquires from the held correspondence information the type of the A-packet corresponding to the MC number of the error packet added to the received error notification data, and restores a type of the error packet. In addition, the first transmission unit and the second transmission unit perform processing related to A-PHY.

A transmission device according to one aspect of the present disclosure includes a transmission unit that receives an A-packet transmitted from another transmission device connected via an A-PHY I/F defined in an MIPI standard, in a case where an error in the A-packet is detected, generates error notification data to which an MC number of an error packet that is the A-packet in which the error has been detected is added, and transmits the generated error notification data to the another transmission device, and the transmission unit performs processing related to A-PHY.

A transmission method according to one aspect of the present disclosure is a transmission method of a transmission device including a transmission unit that performs processing related to A-PHY defined in an MIPI standard, the transmission method including, by the transmission unit, receiving an A-packet transmitted from another transmission device connected via an A-PHY I/F, in a case where an error in the A-packet is detected, generating error notification data to which an MC number of an error packet that is the A-packet in which the error has been detected is added, and transmitting the generated error notification data to the another transmission device.

In the transmission device and the transmission method according to one aspect of the present disclosure, the A-packet transmitted from another transmission device connected via the A-PHY I/F is received by the transmission unit that performs processing related to A-PHY defined in the MIPI standard, and in a case where an error in the A-packet is detected, error notification data to which an MC number of an error packet that is the A-packet in which the error has been detected is added is generated, and the generated error notification data is transmitted to the other transmission device.

A transmission device according to one aspect of the present disclosure is a transmission device including: a transmission unit that transmits an A-packet to another transmission device connected via an A-PHY I/F defined in an MIPI standard, holds correspondence information in which a type of the transmitted A-packet is associated with an MC number of the A-packet, in a case where error notification data transmitted from the another transmission device is received, acquires a type of the A-packet corresponding to an MC number of an error packet added to the received error notification data from the held correspondence information, and restores a type of the A-packet in which an error has been detected as the error packet, in which the transmission unit performs processing related to A-PHY.

A transmission method according to one aspect of the present disclosure is a transmission method of a transmission device including a transmission unit that performs processing related to A-PHY defined in an MIPI standard, the transmission method including, by the transmission unit, transmitting an A-packet to another transmission device connected via an A-PHY I/F, holding correspondence information in which a type of the transmitted A-packet is associated with an MC number of the A-packet, and in a case where error notification data transmitted from the another transmission device is received, acquiring a type of the A-packet corresponding to an MC number of an error packet added to the received error notification data from the held correspondence information, and restoring a type of the A-packet in which an error has been detected as the error packet.

In the transmission device and the transmission method according to one aspect of the present disclosure, an A-packet is transmitted to another transmission device connected via an A-PHY I/F by the transmission unit that performs processing related to A-PHY, correspondence information in which a type of the transmitted A-packet is associated with an MC number of the A-packet is held, and in a case where error notification data transmitted from the another transmission device is received, a type of the A-packet corresponding to an MC number of an error packet added to the received error notification data is acquired from the held correspondence information, and the type of the A-packet in which an error has been detected as the error packet is restored.

Note that the transmission device according to one aspect of the present disclosure may be an independent. device or an internal block constituting one device.

### BRIEF DESCRIPTION OF DRAWINGS

FIG. 1 is a view illustrating a configuration example of an embodiment of a transmission system to which the present disclosure is applied.

FIG. 2 is a view illustrating a first example of a configuration of an error notification packet to which a new scheme is applied.

FIG. 3 is a view illustrating a second example of the configuration of the error notification packet to which the new scheme is applied.

FIG. 4 is a view for explaining IPG+Packet used in a current scheme.

FIG. 5 is a view illustrating a combination of ISS and Idle of EOI of the current scheme.

FIG. 6 is a view for explaining PKTERR+MC to which the new scheme is applied.

FIG. 7 is a view illustrating an example of a combination of ISS and Idle different from EOI in a case where the new scheme is applied.

FIG. 8 is a view illustrating transmission of PKTERR+MC and additional information to which the new scheme is applied.

FIG. 9 is a view illustrating an example of Control Nibbles to which the new scheme is applied.

FIG. 10 is a view for explaining CM+CN+MC to which the new scheme is applied.

FIG. 11 is a view illustrating transmission of CM+CN+MC and additional information to which the new scheme is applied.

FIG. 12 is a view illustrating a configuration example of a source and a sink that can cope with a case where a downlink A-packet is damaged or lost.

FIG. 13 is a view indicating flow of a signal upon notification using an error notification packet in a case where a downlink A-packet is damaged or lost.

FIG. 14 is a view indicating flow of a signal upon notification using CM+CN+MC in a case where a downlink A-packet is damaged or lost.

FIG. 15 is a view illustrating a configuration example of a source and a sink that can cope with a case where an uplink A-packet is damaged or lost.

FIG. 16 is a view indicating flow of a signal upon notification using an error notification packet in a case where an uplink A-packet is damaged or lost.

FIG. 17 is a view indicating flow of a signal upon notification using PKTERR+MC in a case where an uplink A-packet is damaged or lost.

FIG. 18 is a flowchart indicating a series of flow until a notification is given to a sink side in a case where damage or loss of a received packet is detected on a source side.

FIG. 19 is a flowchart indicating flow of processing of reception failure notification and notification analysis to be performed between the source and the sink.

FIG. 20 is a view indicating an example of Adaptation Type.

FIG. 21 is a view indicating an example of Adaptation Type.

FIG. 22 is a flowchart indicating a series of flow until a notification is given to a source side in a case where damage or loss of a received packet is detected on a sink side.

FIG. 23 is a flowchart indicating flow of processing of reception failure notification and notification analysis to be performed between the sink and the source.

FIG. 24 is a sequence diagram indicating signals to be exchanged between the source side and the sink side in a case where the current scheme is used.

FIG. 25 is a sequence diagram illustrating signals to be exchanged between the source side and the sink side in a case where the new scheme is used.

### MODE FOR CARRYING OUT THE INVENTION

### System Configuration

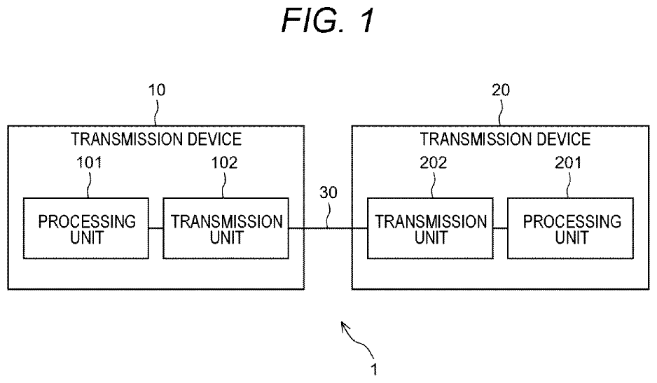

FIG. 1 is a view illustrating a configuration example of an embodiment of a transmission system to which the present disclosure is applied.

In FIG. 1, a transmission system 1 includes a transmission device 10 and a transmission device 20. The transmission device 10 and the transmission device 20 exchange data via a transmission path 30 such as a cable. In the transmission system 1, data is transmitted via an A-PHY network between the transmission device 10 and the transmission device 20. A-PHY is a standard defined by the MIPI Alliance as a physical layer of SerDes for in-vehicle use. In the present disclosure, the standard defined by the MIPI Alliance is referred to as the MIPI standard.

The transmission device 10 includes a processing unit 101 and a transmission unit 102. The processing unit 101 includes a chip that performs processing related to a protocol adaptation layer (PAL), a central processing unit (CPU) that controls operation of each unit of the transmission device 10, and the like. The transmission unit 102 includes a chip that performs processing related to data transmission, and the like. The transmission unit 102 performs processing related to A-PHY (processing of a PHY layer and a Data Link layer). The processing unit 101 performs processing related to an upper layer that is an upper layer of A-PHY.

The transmission device 20 includes a processing unit 201 and a transmission unit 202. The processing unit 201 includes a chip that performs processing related to PAL, a CPU that controls operation of each unit of the transmission device 20, and the like. The transmission unit 202 includes a chip that performs processing related to data transmission, and the like. The transmission unit 202 performs processing related to A-PHY. The processing unit 201 performs processing related to an upper layer that is an upper layer of A-PHY.

In the transmission system 1, one of the transmission device 10 and the transmission device 20 serves as a source (Source), and the other serves as a sink (Sink). The source and the sink are defined in the MIPI standard, and in the following description, a case will be described as an example where the transmission device 10 serves as the source and the transmission device 20 serves as the sink. In addition, transmission from the source to the sink is referred to as downlink, and transmission from the sink to the source is referred to as uplink. A transmission speed (communication speed) is different between the downlink and the uplink, and a downlink transmission speed is higher than an uplink transmission speed.

Here, for example, in the transmission system 1, a case will be assumed where an A-packet is transmitted from the transmission device 10 on the source side to the transmission device 20 on the sink side by serial communication via the transmission path 30. In this case, the processing unit 101 processes data in various schemes such as general purpose input/output (GPIO), inter-integrated circuit (I2C), camera serial interface 2 (CSI2), and serial peripheral interface (SPI). The processing unit 101 generates an A-packet from data in various schemes.

The transmission unit 102 transmits the A-packet generated by the processing unit 101. In this event, a message counter (MC) number is added to the A-packet to be transmitted. For example, the MC number is a value from 0 to 255, and a different number is added for each A-packet. In this example, the MC number can be continuously added by setting a start value to 0, incrementing for each A-packet, and returning to 0 when the value becomes 255. The transmission unit 102 can hold a transmission table as correspondence information in which a type of the transmitted A-packet is associated with the MC number. In other words, the MC number is added to the A-packet to be transmitted, and thus, the transmission table in which the type (protocol type) of the data stored in the A-packet is associated with the MC number added to the A-packet can be held until a certain period elapses from the transmission of the A-packet.

For example, in the transmission table, MC=0, MC=1, MC=2, MC=3, and the like, are respectively associated with GPIO, CSI2, CSI2 and I2C.

In this event, upon occurrence of an error in the A-packet being transmitted, the transmission unit 202 of the sink detects the occurrence of the error, generates error notification data, and transmits the error notification data to the transmission unit 102 of the Source. The error notification data includes the MC number of the error packet which is the A-packet in which the error has been detected. Upon reception of the error notification data transmitted from the transmission unit 202, the transmission unit 102 refers to the held transmission table and acquires a type (protocol type) of the A-packet corresponding to an MC number of the error packet included in the error notification data. As a result, the transmission unit 102 can restore the type of the error packet and notify the processing unit 101 of the type of the error packet.

Note that, even if an error has occurred in a case where the A-packet is transmitted from the transmission device 20 on the sink side to the transmission device 10 on the source side, basically similar processing is performed while the processing on the source side and the processing on the sink side are reversed, but the detailed description thereof will be described later.

As described above, the transmission system 1 employs a scheme in which the transmission unit 102 or the transmission unit 202 that performs processing related to the A-PHY directly notifies the counterpart transmission unit that an error has occurred in the A-packet transmitted between the transmission device 10 on the source side and the transmission device 20 on the sink side. As this new scheme, any one of the following three notification methods can be used.

The first notification method is a method in which a packet (Packet Error Notification Packet) for making a notification of an error in the A-packet is newly defined, and a notification of occurrence of the error is made by the packet. The second notification method is a method in which a format of PKTERR+MC is newly defined for an IPG+Packet used in the current scheme, and a notification of occurrence of an error in the A-packet is made by PKTERR+MC. Details of IPG+Packet, PKTERR+MC will be described later. The third notification method is a method in which a format of packet error indication (PER) is newly defined in control nibbles (CN) for CM+CN used in the current scheme, and a notification of occurrence of an error in the A-packet is made by CM+CN+MC. Details of CM+CN, CM+CN+MC will be described later. Details of the three notification methods will be sequentially described below.

### First Notification Method

In the first notification method, a packet (Packet Error Notification Packet, hereinafter, also referred to as an error notification packet) for making a notification of an error in the A-packet is newly defined, and a notification of occurrence of the error is made by the packet.

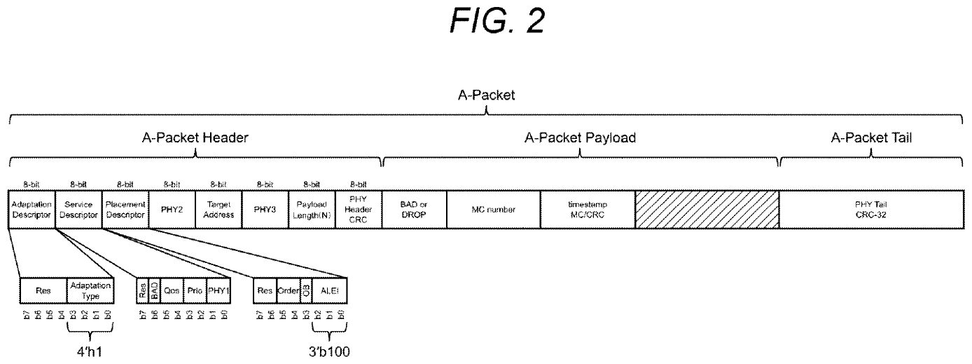

FIG. 2 is a view illustrating a first example of a configuration of an error notification packet to which the new scheme is applied. As illustrated in FIG. 2, the error notification packet is configured as an A-packet. In FIG. 2, the A-packet includes an A-packet header, an A-packet payload, and an A-packet tail.

The A-packet header includes a field of Adaptation Descriptor of eight bits, a field of Service Descriptor of eight bits, a field of Placement Descriptor of eight bits, a field of PHY2 of eight bits, a field of Target Address of eight bits, a field of PHY3 of eight bits, a field of Payload Length of eight bits, and a field of PHY Header CRC of eight bits.

The Adaptation Descriptor includes a field of Adaptation Type of four bits, and the remaining bits are Reserved (Res). The Service Descriptor includes a field of PHY1 of two bits, a field of Priority (Prio) of two bits, a field of Quality of Service (QoS) of two bits, and a field of Bad Indication (BAD) of one bit, and the remaining bits are Reserved (Res). The Placement Descriptor includes a field of Adaptation Layer specific information (ALEI) of three bits, a field of Odd-Bytes (OB) of one bit, and a field of Order of two bits, and the remaining bits are Reserved (Res).

A value of Adaptation Type of Adaptation Descriptor is 4′hl. In a case where the value of Adaptation Type is set at 1(4′h1), it indicates that the service is a Link service. A value of ALEI is 3′b100. Here, ALEI=3′b000, 3′b001 has already been defined in the current scheme, and thus, unused ALEI=3′b100 is used in the new scheme.

The A-packet payload includes fields of BAD or DROP, MC number, and timestamp. BAD or DROP is a field in which a damage/loss flag indicating that an error packet is a damaged (BAD) or lost (DROP) packet is arranged. MC number is a field in which the MC number of the error packet is arranged. Timestamp is a field in which a timestamp is arranged. Note that the error notification packet in FIG. 2 is a packet defined by the Link service and can be retransmitted.

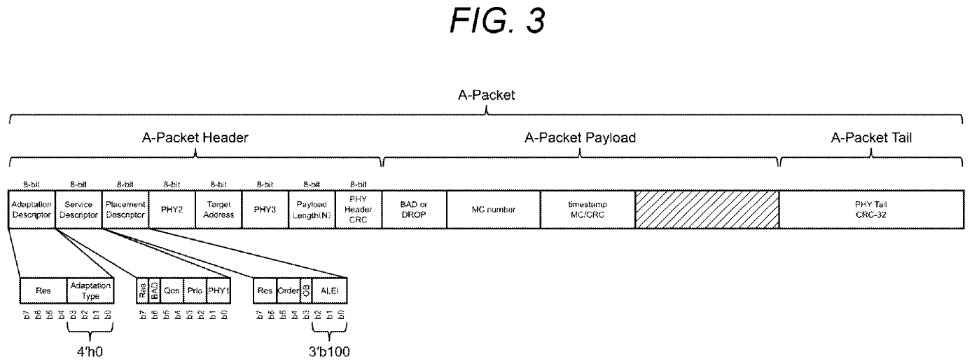

FIG. 3 is a view illustrating a second example of the configuration of the error notification packet to which the new scheme is applied. In FIG. 3, the error notification packet configured as the A-packet is configured in a similar manner to the configuration in FIG. 2, but the value of Adaptation Type is different. In other words, in the A-packet header, the value of Adaptation Type of Adaptation Descriptor is 4′h0. In a case where the value of Adaptation Type is set at 0(4′h0), it indicates that the service is a PHY service. A value of ALEI is 3′b100. In FIG. 3, the A-packet payload includes fields of BAD or DROP, MC number, and timestamp. Note that the error notification packet in FIG. 3 is a packet defined by the PHY service and cannot be retransmitted.

As described above, in the first notification method, the error notification packet that is the packet for making a notification of the error in the A-packet is defined in the packet defined in the Link service or the PHY service defined in the MIPI standard, and a notification of occurrence of the error can be made by the packet. The first notification method can be used in both uplink and downlink. For example, the transmission unit 102 of the source can transmit an error notification packet to the transmission unit 202 of the sink to make a notification of occurrence of the error in the A-packet. Furthermore, the transmission unit 202 of the sink can transmit an error notification packet to the transmission unit 102 of the source to make a notification of occurrence of the error in the A-packet.

### Second Notification Method

In the second notification method, a format of PKTERR+MC is newly defined for IPG+Packet used in the current scheme, and a notification of occurrence of a packet error is made by PKTERR+MC. The second notification method can be used in downlink.

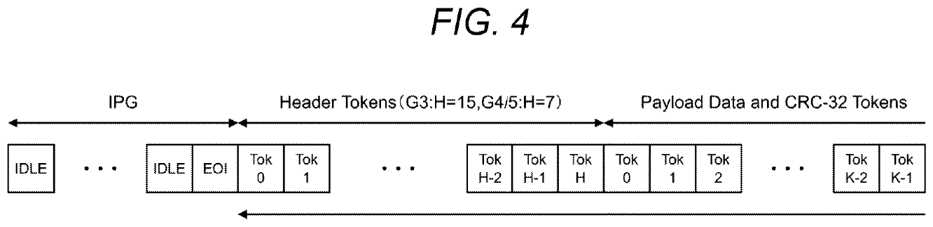

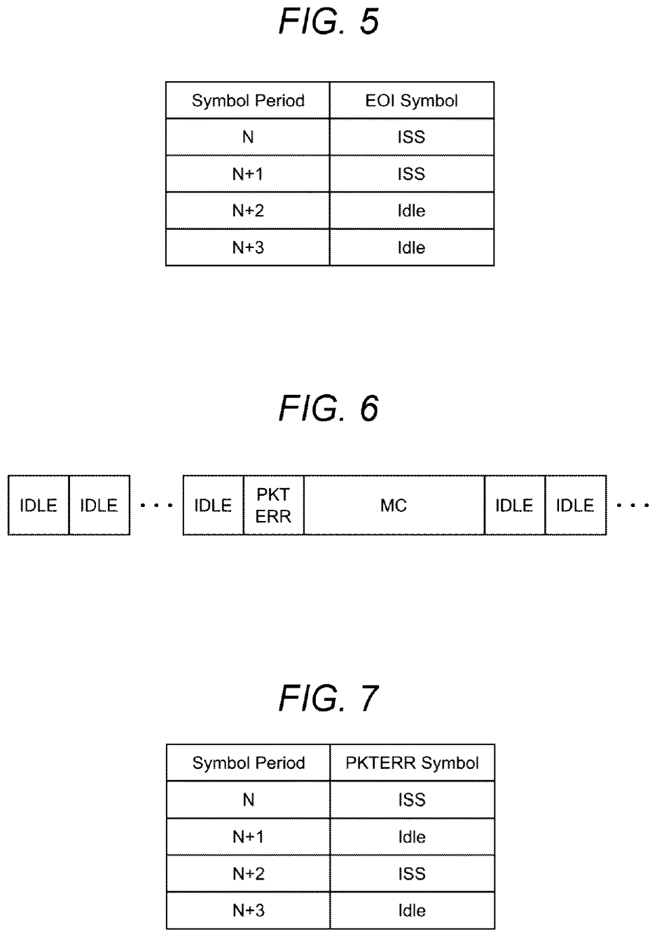

IPG+Packet used in the current scheme will be described with reference to FIGS. 4 and 5. FIG. 4 illustrates downlink transmission, and an interpacket gap (IPG) is provided before an A-packet represented by Header Tokens, and Payload Data and CRC-32 Tokens. In other words, a state between the A-packet and the A-packet becomes an IDLE state. In a case where end of idle (EOI) comes after the last IDLE in IPG, the A-packet is transmitted subsequently. As illustrated in FIG. 5, EOI of the current scheme is defined by a combination of ISS and Idle set for each Symbol Period.

FIG. 6 is a view for explaining PKTERR+MC to which the new scheme is applied. FIG. 6 illustrates downlink transmission, and PKTERR+MC is transmitted during IDLE in IPG. PKTERR+MC includes a code (PKTERR) indicating a packet error and an MC number (MC) added to the code. A notification of PKTERR+MC can be made by using a combination of ISS and Idle different from EOI defined in the current scheme. FIG. 7 is a view illustrating an example of a combination of ISS and Idle different from EOI in a case where the new scheme is applied. In FIG. 7, the combination of ISS and Idle set for each Symbol Period is different from that in FIG. 5. This makes it possible to distinguish between EOI and PKTERR in IPG.

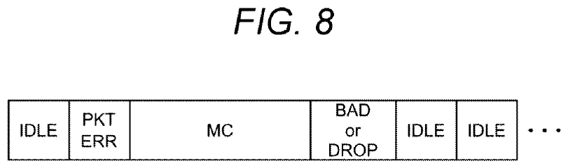

As described above, by mixing the code of PKTERR (code other than 0) with the IDLE data transmitted during the A-packet, it is possible to make a notification of the MC number added to PKTERR together with the code of PKTERR indicating a packet error. Further, additional information can be added to PKTERR+MC. For example, as illustrated in FIG. 8, additional information that is BAD or DROP, that is, a damage/loss flag indicating that the error packet is a damaged or lost packet can be added.

As described above, in the second notification method, PKTERR+MC is defined, and a notification of Occurrence of the error in the A-packet can be made by PKTERR+MC. The second notification method can be used in downlink, and for example, the transmission unit 102 of the source can transmit PKTERR+MC to the transmission unit 202 of the sink to make a notification of occurrence of the error in the A-packet. In the second notification method, the code is used, and thus, a data length can be shortened as compared with a case where the packet is used in the first notification method, and PKTERR+MC can be transmitted in a shorter period.

### Third Notification Method

In the third notification method, a new format of CM+CN is defined by newly defining packet error indication (PER) in control nibbles (CN) for CM+CN used in the current scheme, thereby, a notification of occurrence of a packet error is made by CM+CN+MC. The third notification method can be used in uplink.

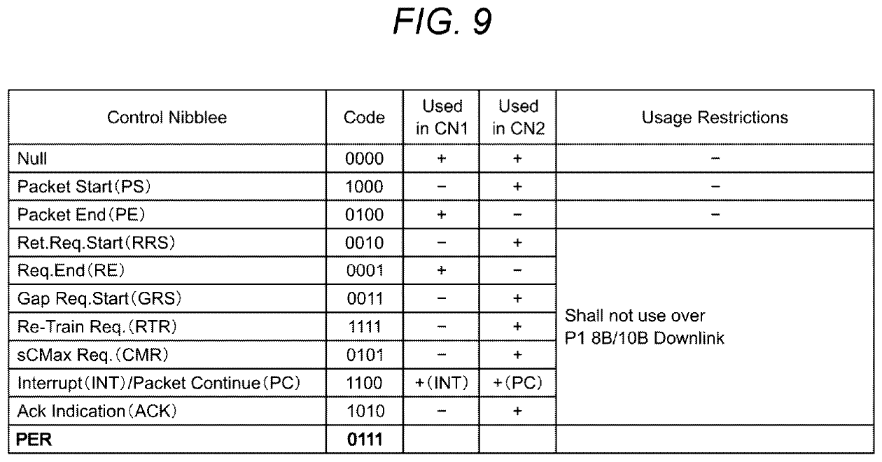

FIG. 9 is a view illustrating an example of control nibbles (CN) to which the new scheme is applied. In FIG. 9, Null, Packet Start (PS), Packet End (PE), Ret. Req. Start (RRS), Req. End (RE), Gap Req. Start (GRS), Re-Train Req. (RTR), sCMax Req. (CMR), Interrupt (INT)/Packet Continue (PC), and Ack Indication (ACK) are CN defined by the current scheme. In FIG. 9, Packet Error Indication (PER) is CN newly defined by the new scheme, and indicates a packet error. As the code (Code) of PER, 0111 that is unused in the current scheme can be used. As a result, a new format of CM+CN can be used. Note that CN includes CN1 and CN2.

In the uplink of the current scheme, each request. or packet is transmitted by consecutively transmitting CM+CN, that is, Control Mark (CM) and Control Nibbles (CN). In the uplink of the new scheme, it is possible to transmit CM+CN+MC in which an MC number is added to CM+CN by designating PER for CN and using a new format of CM+CN.

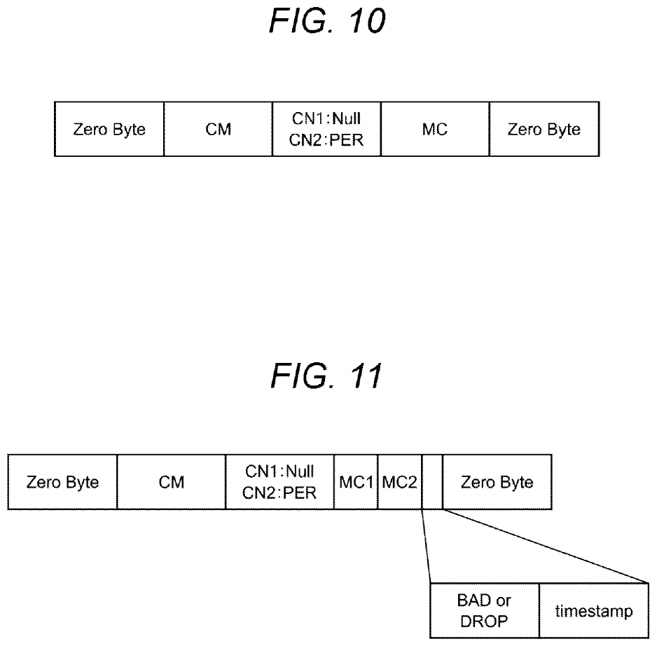

FIG. 10 is a view for explaining CM+CN+MC to which the new scheme is applied. FIG. 10 illustrates uplink transmission. CN1=Null (0000) and CN2=PER (0111) are designated by CN following CM, and a notification of occurrence of a packet error is made. In addition, a notification of the MC number is made by MC following CN. By adopting the format of FIG. 10, it is possible to make a notification of the MC number of the A-packet in which the error has occurred.

The format of CM+CN+MC is not limited to the format of FIG. 10, and for example, other formats as illustrated in FIG. 11 may be adopted. In FIG. 11, in a similar manner to FIG. 10, CN1=Null and CN2=PER are designated, and a notification of occurrence of the packet error is made. Further, in FIG. 11, a plurality of MC numbers can be designated by MC1 and MC2. For example, a plurality of MC numbers can be designated in a range from MC1 to MC2, that is, a range from the MC number designated by MC1 to the MC number designated by MC2. As a result, in a case where an error has occurred in the A-packet, a notification of a plurality of MC numbers can be made. Further, information such as BAD or DROP indicating a damage/loss flag and timestamp indicating a timestamp may be added.

As described above, in the third notification method, CM+CN+MC is defined, and a notification of occurrence of the error in the A-packet can be made by CM+CN+MC. The third notification method can be used in uplink, and for example, the transmission unit 202 of the sink can transmit CM+CN+MC to the transmission unit 102 of the source to make a notification of occurrence of the error in the A− packet. In the third notification method, the code, or the like, is used, and thus, a data length can be shortened as compared with a case where the packet is used in the first notification method, and CM+CN+MC can be transmitted in a shorter period.

### A. Case Where Downlink A-Packet is Damaged/Lost

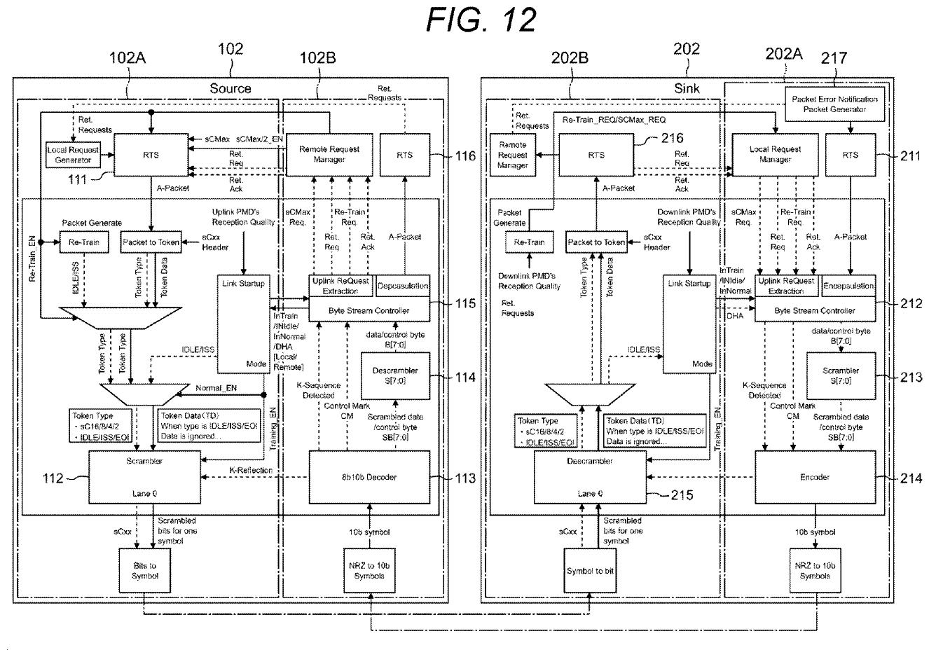

Operation of the source and the sink in a case where a downlink A-packet is damaged or lost will be described with reference to FIGS. 12 to 14. FIG. 12 is a view illustrating a configuration example of the source and the sink that can cope with a case where the downlink A-packet is damaged or lost. In FIG. 12, the transmission unit 102 of the transmission device 10 is illustrated as a configuration of the source, and the transmission unit 202 of the transmission device 20 is illustrated as a configuration of the sink.

The transmission unit 102 of the source includes a transmitting system 102A and a receiving system 102B. The transmitting system 102A includes a retransmission (RTS) 111 that performs processing related to retransmission, and the like, a scrambler 112 that scrambles a signal, and the like. The receiving system 102B includes a decoder 113 that decodes a signal, a descrambler 114 that descrambles a signal, a stream controller 115 that controls a stream, an RTS 116 that performs processing related to retransmission, and the like.

The transmission unit 202 of the sink includes a transmitting system 202A and a receiving system 202B. The transmitting system 202A includes an RTS 211 that performs processing related to retransmission, and the like, a stream controller 212 that controls a stream, a scrambler 213 that scrambles a signal, an encoder 214 that encodes a signal, a packet generation unit 217 that generates an error notification packet, and the like. However, in a case where a notification method other than the first notification method is used, it is not necessary to provide the packet generation unit 217. The receiving system 202B includes a descrambler 215 that descrambles a signal, an RTS 216 that performs processing related to retransmission, and the like.

Note that the transmitting system and the receiving system in the transmission unit 102 and the transmission unit 202 are separated for convenience of description, and part of the receiving system may operate as necessary at the time of transmission, or part of the transmitting system may operate as necessary at the time of reception.

### a1. First Notification Method: Error Notification Packet

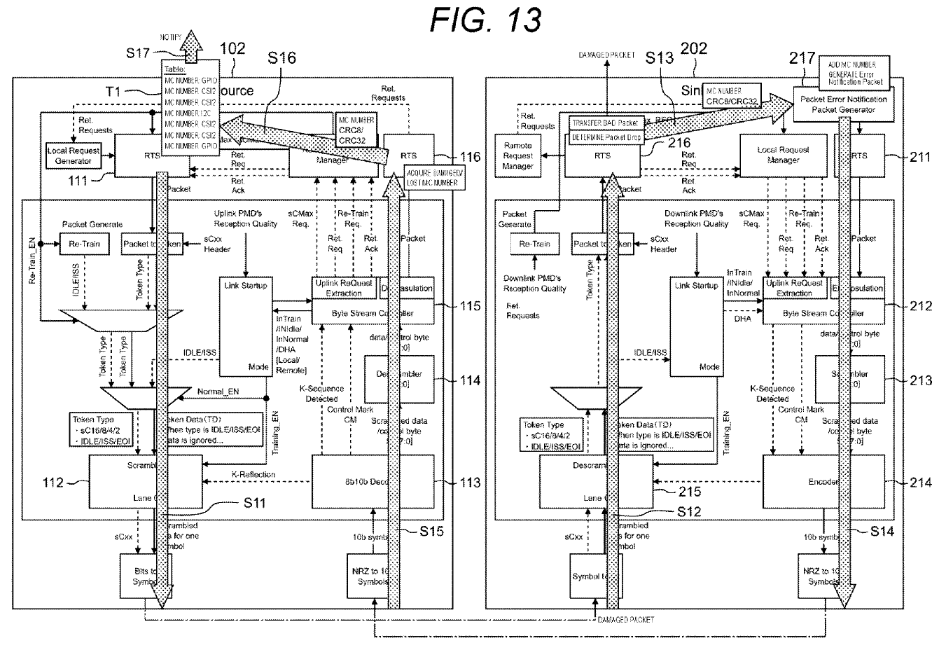

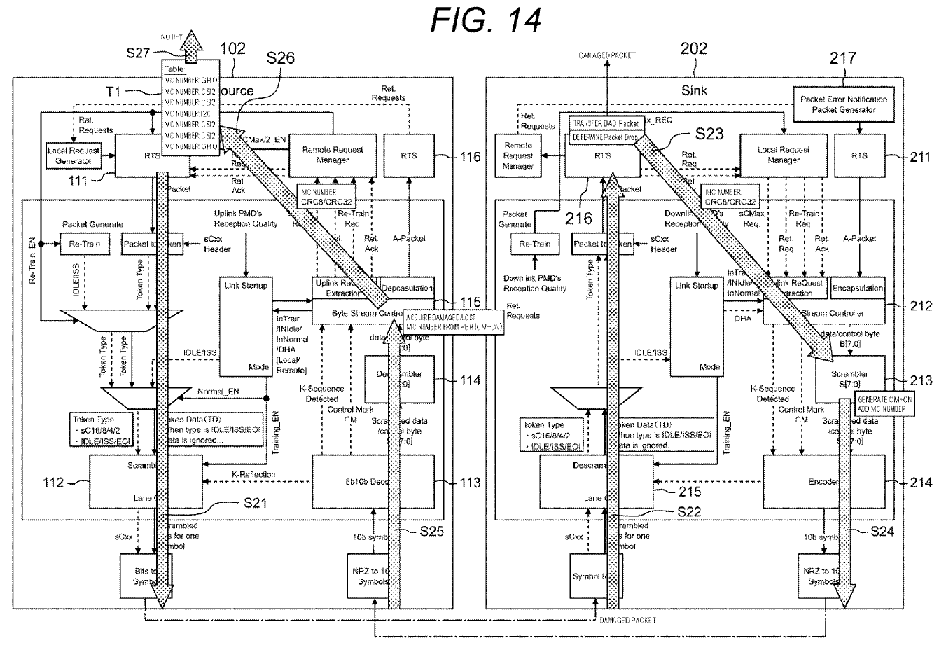

FIG. 13 is a view indicating flow of a signal upon notification of occurrence of an error using an error notification packet in a case where a downlink A-packet is damaged or lost in the configuration of the source and the sink of FIG. 12. In FIG. 13, the flow of the signal is represented by a patterned arrow.

In FIG. 13, in the transmission unit 102 of the Source, each unit of the transmitting system 102A performs processing to transmit A-packets in the order of the MC number in a transmission table T1 (S11). In the transmission unit 202 of the sink, each unit of the receiving system 202B performs processing to receive the A-packets transmitted from the transmission unit 102 (S12). In this event, a case is assumed where the received A-packet is damaged. In the transmission unit 202, the receiving system 202B detects damage or loss of the received A-packet and transfers the damaged packet to the processing unit 201 that performs processing related to the upper layer. In addition, the receiving system 202B notifies the packet generation unit 217 of the transmitting system 202A of the MC number of the damaged A-packet (S13).

The packet generation unit 217 generates an error notification packet to which the notified MC number is added (S13). In the transmitting system 202A, each unit performs processing to transmit the error notification packet generated by the packet generation unit 217 (S14). In the transmission unit 102, each unit of the receiving system 102B performs processing to receive the error notification packet transmitted from the transmission unit 202 (S15). The receiving system 102B acquires the MC number of the damaged A-packet from the received error notification packet and notifies the transmitting system 102A of the MC number (S16). The transmitting system 102A acquires a protocol type of the target MC number for which the notification has been made from the transmission table T1 held also after an overall delay, and notifies the processing unit 101 that performs processing related to the upper layer of the protocol type (S17). Here, it is defined that after the packet being held for a certain period, the packet is no longer held until the packet is not transmitted from the Counterpart (there is no possibility of being transmitted) due to the overall delay.

### a2. Third Notification Method: CM+CN+MC

FIG. 14 is a view indicating flow of a signal upon notification of occurrence of an error using CM+CN+MC in a case where a downlink A-packet is damaged or lost in the configuration of the source and the sink of FIG. 12. Also in FIG. 14, the flow of the signal is represented by a patterned arrow.

In FIG. 14, in the transmission unit 102 of the source, each unit of the transmitting system 102A performs processing to transmit A-packets in the order of the MC number in the transmission table T1 (S21). In the transmission unit 202 of the sink, each unit of the receiving system 202B performs processing to receive the A-packets transmitted from the transmission unit 102 (S22). In this event, a case is assumed where the received A-packet is damaged. In the transmission unit 202, the receiving system 202B detects damage or loss of the received A-packet and transfers the damaged packet to the processing unit 201 that performs processing related to the upper layer. In addition, the receiving system 202B notifies the transmitting system 202A of the MC number of the damaged A-packet (S23).

The transmitting system 202A generates CM+CN+MC in which the notified MC number is added to CMICN in which CN1=Null and CN2=PER are designated (S23). The transmitting system 202A transmits the generated CM+CN+MC (S24). In the transmission unit 102, each unit of the receiving system 102B performs processing to receive CM+CN+MC transmitted from the transmission unit 202 (S25). Here, the third notification method that can be used in uplink is adopted, and the transmission unit 202 of the sink transmits CM+CN+MC to the transmission unit. 102 of the source to make a notification of occurrence of the error in the A-packet. The receiving system 102B acquires the MC number of the damaged A-packet from the received CM+CN+MC and notifies the transmitting system 102A of the acquired MC number (S26). The transmitting system 102A acquires a protocol type of the MC number for which the notification has been made from the transmission table T1 held after the overall delay, and notifies the processing unit 101 that performs processing related to the upper layer of the protocol type (S27).

### B. Case Where Uplink A-Packet is Damaged/Lost

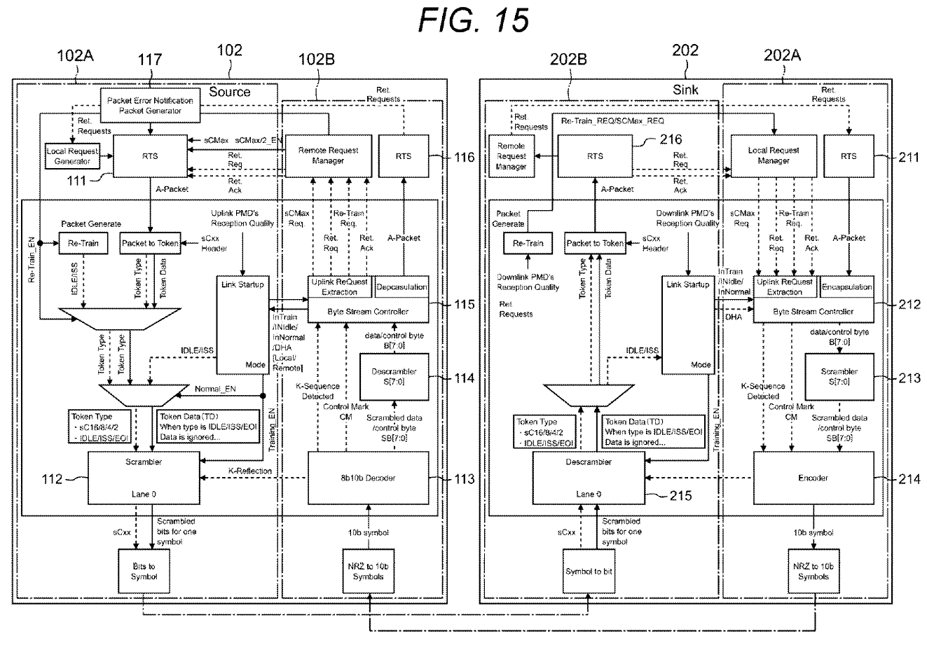

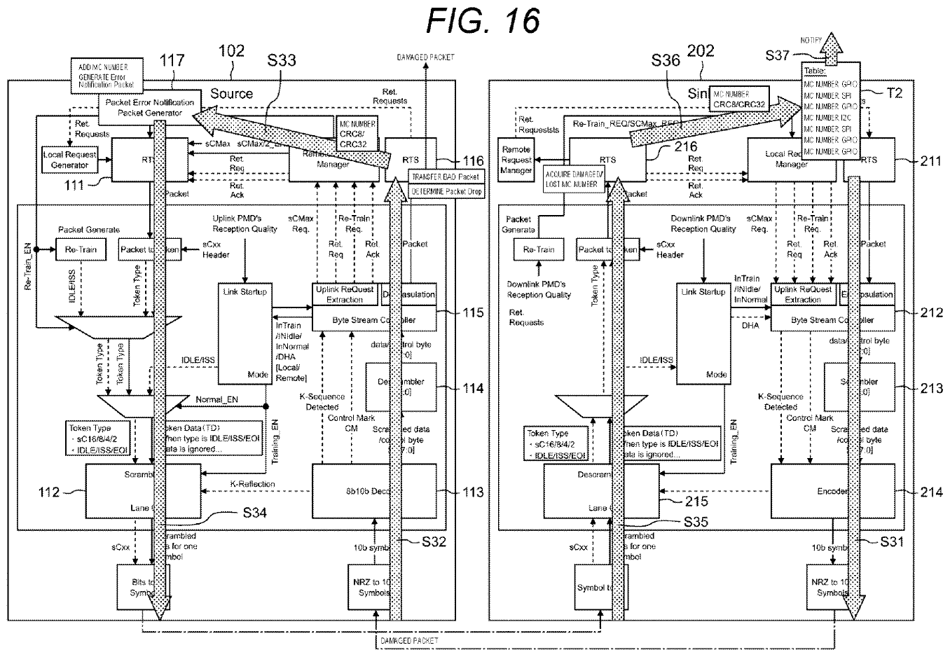

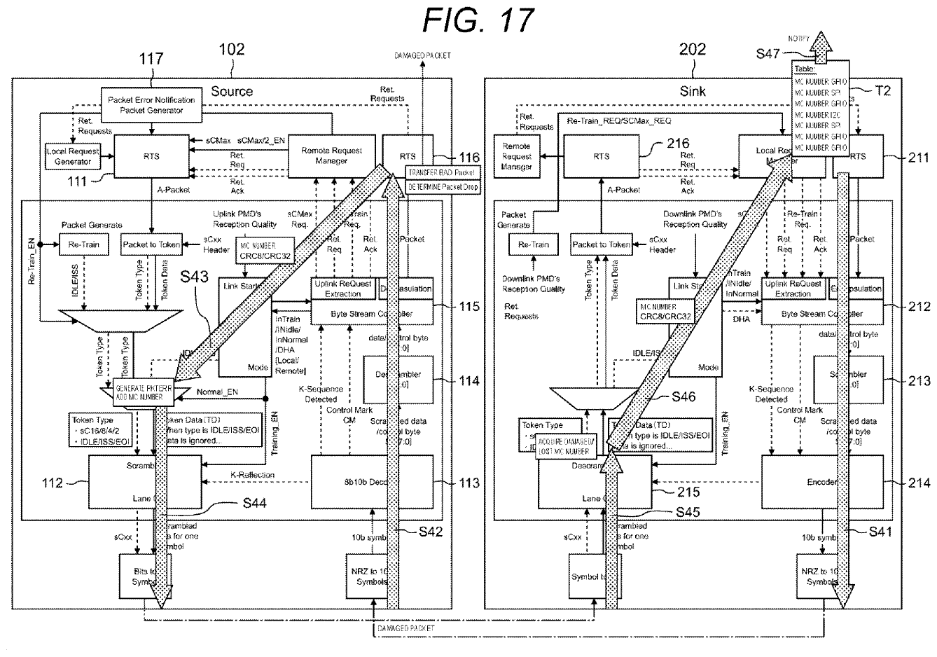

Operation of the source and the sink in a case where an uplink A-packet is damaged or lost will be described with reference to FIGS. 15 to 17. FIG. 15 is a view illustrating a configuration example of the source and the sink that can cope with a case where the uplink A-packet is damaged or lost. In FIG. 15, in a similar manner to FIG. 12, the transmission unit 102 of the transmission device 10 is illustrated as the configuration of the source, and the transmission unit 202 of the transmission device 20 is illustrated as the configuration of the sink.

In FIG. 15, the transmission unit 102 has a configuration in which a packet generation unit 117 that generates an error notification packet is added to the transmitting system 102A as compared with the configuration illustrated in FIG. 12. The transmission unit 202 has a configuration in which the packet generation unit 217 provided in the transmitting system 202A is removed as compared with the configuration illustrated in FIG. 12. Other components are the same as those illustrated in FIG. 12, and thus, the description thereof will be omitted.

### b1. First Notification Method: Error Notification Packet

FIG. 16 is a view indicating flow of a signal upon notification of occurrence of an error using the error notification packet in a case where the uplink A-packet is damaged or lost in the configuration of the source and the sink of FIG. 15. In FIG. 16, the flow of the signal is represented by a patterned arrow.

In FIG. 16, in the transmission unit 202 of the sink, each unit of the transmitting system 202A performs processing to transmit A-packets in the order of the MC number of the transmission table T2 (S31). In the transmission unit 102 of the source, each unit of the receiving system 102B performs processing to receive the A-packets transmitted from the transmission unit 202 (S32). In this event, a case is assumed where the received A-packet is damaged. In the transmission unit 102, the receiving system 102B detects the damage or the loss of the received A-packet and transfers the damaged packet to the processing unit 101 that performs processing related to the upper layer. In addition, the receiving system 102B notifies the packet generation unit 117 of the transmitting system 102A of the MC number of the damaged A-packet (S33).

The packet generation unit 117 generates an error notification packet to which the notified MC number is added (S33). In the transmitting system 102A, each unit performs processing to transmit the error notification packet generated by the packet generation unit 117 (S34). In the transmission unit 202, each unit of the receiving system 202B performs processing to receive the error notification packet transmitted from the transmission unit 102 (S35). The receiving system 202B acquires the MC number of the damaged A-packet from the received error notification packet and notifies the transmitting system 202A of the MC number (S36). The transmitting system 202A acquires a protocol type of the MC number for which the notification has been made from the transmission table T2 held after the overall delay, and notifies the processing unit 201 that performs processing related to the upper layer of the protocol type (S37).

### b2. Second Notification Method: PKTERR+MC

FIG. 17 is a view indicating flow of a signal upon notification of occurrence of an error using PKTERR+MC in a case where an uplink A-packet is damaged or lost in the configuration of the source and the sink of FIG. 15. Also in FIG. 17, the flow of the signal is represented by a patterned arrow.

In FIG. 17, in the transmission unit 202 of the sink, each unit of the transmitting system 202A performs processing to transmit A-packets in the order of the MC number of the transmission table T2 (S41). In the transmission unit 102 of the source, each unit of the receiving system 102B performs processing to receive the A-packets transmitted from the transmission unit 202 (S42). In this event, a case is assumed where the received A-packet is damaged. In the transmission unit 102, the receiving system 102B detects the damage or the loss of the received A-packet and transfers the damaged packet to the processing unit 101 that performs processing related to the upper layer. In addition, the receiving system 102B notifies the transmitting system 102A of the MC number of the damaged A-packet (S43).

The transmitting system 102A generates PKTERR+MC obtained by adding the notified MC number to the code which is PKTERR (S43). The transmitting system 102A transmits the generated PKTERR+MC (S44). In the transmission unit 202, each unit of the receiving system 202B performs processing to receive PKTERR+MC transmitted from the transmission unit 102 (S45). Here, the second notification method that can be used in downlink is adopted, and the transmission unit 102 of the source transmits PKTERR+MC to the transmission unit 202 of the sink to make a notification of occurrence of the error in the A-packet. The receiving system 202B acquires the MC number of the damaged A-packet from the received PKTERR+MC and notifies the transmitting system 202A of the MC number (S46). The transmitting system 202A acquires a protocol type of the target MC number for which the notification has been made from the transmission table 12 held after the overall delay, and notifies the processing unit 201 that performs processing related to the upper layer of the protocol type (S47).

### Processing Flow

a. Detection of Damage/Loss on Source Side

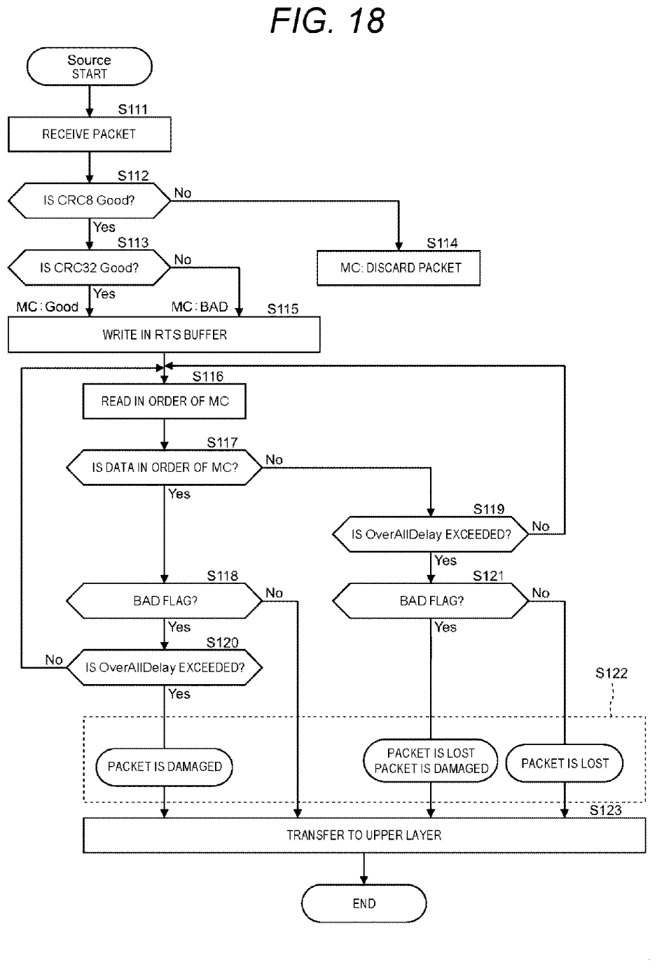

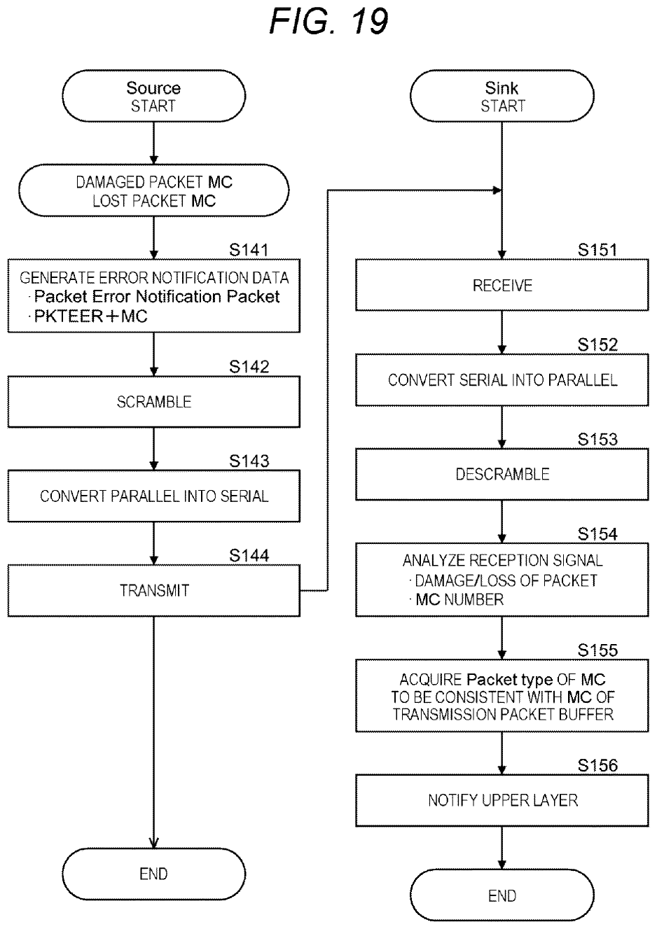

With reference to the flowcharts of FIGS. 18 and 19, a series of flow until the sink side is notified in a case where damage or loss of a received packet is detected on the source side will be described. In the description of FIGS. 18 and 19, a case will be described as an example where (the transmission unit 102 of) the transmission device 10 serves as the source and (the transmission unit 202 of) the transmission device 20 serves as the sink.

In the flowchart of FIG. 18, the receiving system 102B of the transmission unit 102 of the source executes processing from steps S111 to S123 (where processing of S122 is excluded). In other words, the receiving system 102B receives the A-packet transmitted from the transmission unit 202 (S111), and determines whether CRC8 of the header of the received A-packet and CRC32 of the data are Good (have no error) (S112, S113). In a case where it is determined that CRC8 is not Good (S112: No), the corresponding packet is discarded (S114). Further, in a case where it is determined that CRC8 and CRC32 are Good (S112: Yes, S113: Yes), the MC number is Good. On the other hand, in a case where it is determined that CRC8 is Good but CRC32 is not Good (S112: Yes, S113: No), the MC number is BAD. In the receiving system 102B, the information regarding the MC number is written in an RTS buffer together with the data of the received A-packet (S115).

Thereafter, the receiving system 102B reads the data written in the RTS buffer in the order of the MC number (S116) and determines whether the data is in the order of the MC number (S117). In a case where it is determined that the data is in the order of the MC numbers (S117: Yes), it is determined whether the BAD flag is included (S118). In a case where it is determined that the BAD flag is not included (S118: No), the A-packet that has been normally received is transferred to the upper layer (S123). On the other hand, in a case where it is determined that the BAD flag is included (S118: Yes), it is determined whether the overall delay has been exceeded (S120). In a case where it is determined that the overall delay has been exceeded (S120: Yes), the A-packet is damaged, and thus, processing to which the new scheme is applied is executed (S122). Details of the processing (S122) to which the new scheme is applied will be described later with reference to the flowchart of FIG. 19.

In a case where it is determined that the data is not in the order of the MC numbers (S117: No), it is determined whether the overall delay has been exceeded (S119). In a case where it is determined that the overall delay has been exceeded (S119: Yes), it is determined whether the BAD flag is included (S121). In a case where it is determined that the BAD flag is included (S121: Yes), the A-packet is lost or damaged, and thus, processing to which the new scheme is applied is executed (S122). In addition, in a case where it is determined that the BAD flag is not included (S121: No), the A-packet is lost, and thus, processing to which the new scheme is applied is executed (S122). Details of the processing (S122) to which the new scheme is applied will be described later with reference to the flowchart of FIG. 19.

In a case where it is determined that the overall delay has not been exceeded (S119: No, S120: No), the processing returns to step S116, the data written in the RTS buffer is read again in the order of the MC number, and the above-described processing is repeated.

Here, the processing to which the new scheme is applied, and which corresponds to step S122 in FIG. 18 will be described in detail with reference to a flowchart of FIG. 19. In the flowchart of FIG. 19, the processing from steps S141 to S144 is executed by the transmitting system 102A of the transmission unit 102 of the source, and the processing from steps S151 to S156 is executed by part of the receiving system 202B and the transmitting system 202A of the transmission unit 202 of the sink.

In other words, the damage or the loss of the A-packet received by the above-described processing indicated in FIG. 18 is detected, and thus, in the transmission unit 102, the transmitting system 102A generates the error notification data for making a notification of a reception failure of the A-packet using the MC number of the damaged or lost A-packet (S141). Here, it is downlink, and thus, an error notification packet can be generated using the first notification method or PKTERR+MC can be generated using the second notification method. The transmitting system 102A scrambles the generated error notification data (S142), converts the scrambled signal from a parallel signal to a serial signal (S143) and transmits the converted signal (S144).

In the transmission unit 202, the receiving system 202B receives the signal transmitted from the transmission unit 102 by serial communication (S151) and converts the received signal from the serial signal to the parallel signal (S152). Furthermore, the receiving system 202B descrambles the converted signal (S153) and analyzes a reception signal obtained as a result (S154). Here, in a case where the first notification method is used, the MC number of the damaged or lost A-packet is acquired from the error notification packet. Further in a case where the second notification method is used, the MC number of the damaged or lost A-packet is acquired from PKTERR+MC. Then, the transmitting system 202A checks consistency between the MC number of the error packet acquired from the error notification data and the MC number of the transmission packet buffer by referring to the transmission table T2, acquires a packet type (protocol type) of the target MC number (S155) and notifies the upper layer of the packet type (S156).

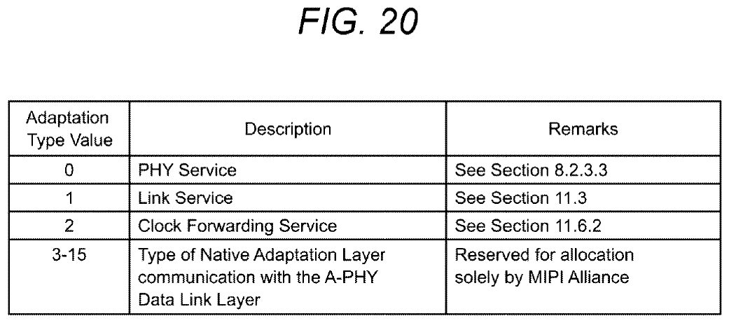

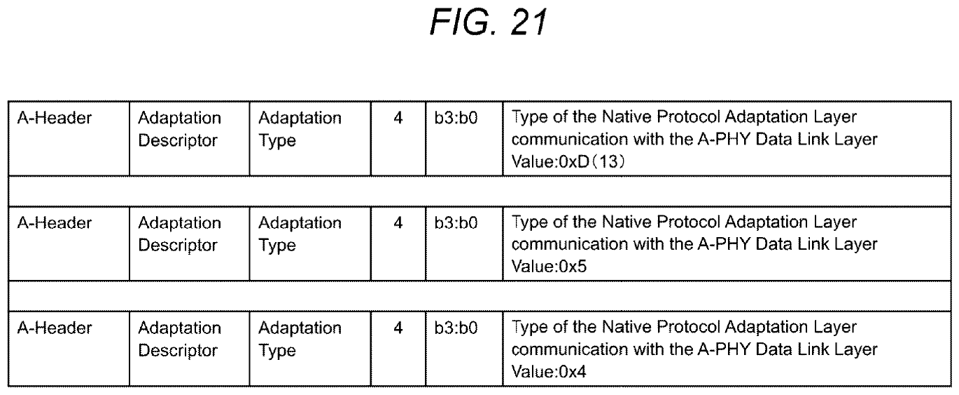

Furthermore, in this event, the transmission unit 202 of the sink can restore Adaptation Type included in Adaptation Descriptor of the header of the error packet from the MC number of the error packet acquired from the error notification data transmitted from the transmission unit 102 of the source. As a result, the transmission unit 202 of the sink can notify the upper layer for each Adaptation Type. FIGS. 20 and 21 illustrate Adaptation Type defined in the MIPI standard.

b. Detection of Damage/Loss on Sink Side

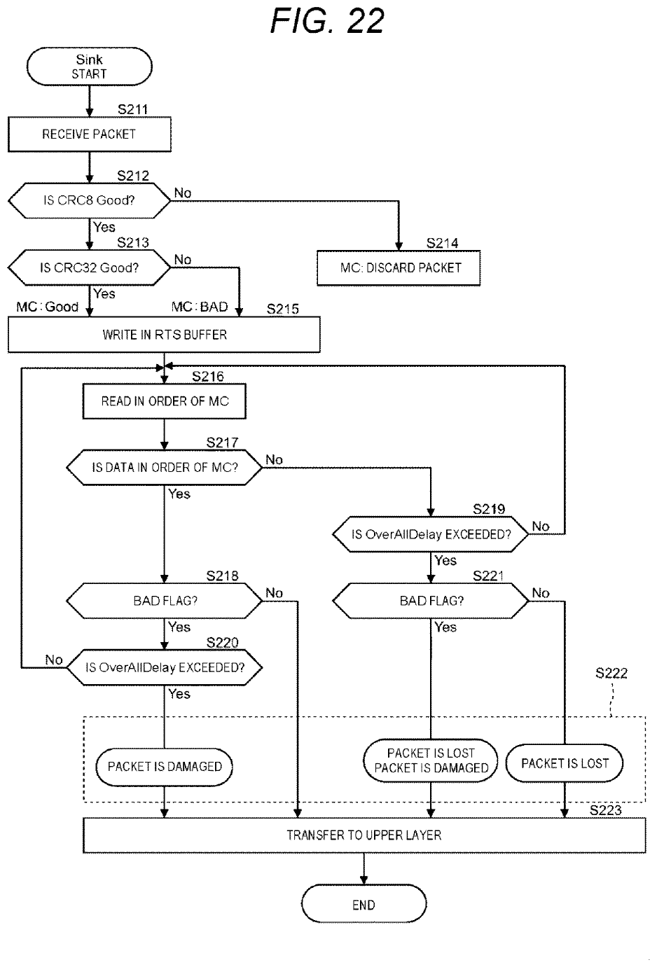

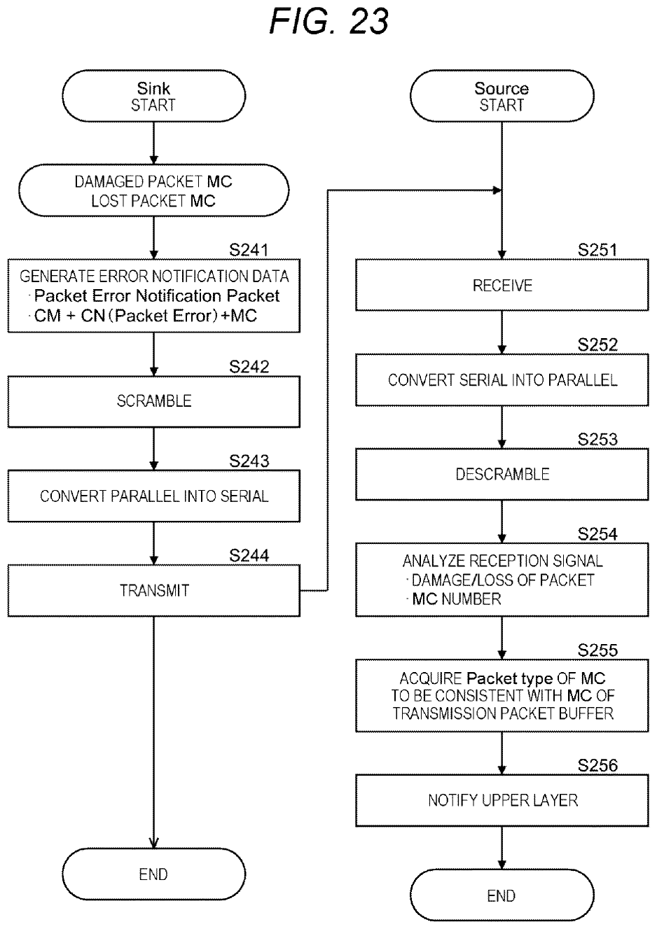

Next, with reference to the flowcharts of FIGS. 22 and 23, a series of flow until the source side is notified in a case where damage or loss of a received packet is detected on the sink side will be described. In the description of FIGS. 22 and 23, in a similar manner to FIGS. 18 and 19, a case will be described as an example where (the transmission unit 102 of) the transmission device 10 serves as the source and (the transmission unit. 202 of) the transmission device 20 Serves as the sink.

In the flowchart of FIG. 22, processing from steps S211 to S223 (where processing of S222 is excluded) is similar to the processing from steps S111 to S123 of FIG. 18 (where the processing of S122 is excluded), but is different in that the subject of the processing is not the receiving system 102B of the transmission unit 102 of the source but the receiving system 202B of the transmission unit 202 of the sink. The processing in step S222 in FIG. 22 is processing to which the new scheme is applied, and details of the processing will be described with reference to the flowchart in FIG. 23. In the flowchart of FIG. 23, the processing from steps S241 to 244 is executed by the transmitting system 202A of the transmission unit 202 of the sink, and the processing from steps S251 to S256 is executed by part of the receiving system 102B and the transmitting system 102A of the transmission unit 102 of the source.

In other words, the damage or the loss of the A-packet received by the above-described processing indicated in FIG. 22 is detected, and thus, in the transmission unit 202, the transmitting system 202A generates the error notification data for making a notification of a reception failure of the A-packet using the MC number of the damaged or lost A-packet (S241). Here, it is uplink, and thus, an error notification packet can be generated using the first notification method, or CM+CN+MC can be generated using the third notification method. The transmitting system 202A scrambles the generated error notification data (S242), converts the scrambled signal from a parallel signal to a serial signal (S243) and transmits the converted signal (S244).

In the transmission unit 102, the receiving system 102B receives the signal transmitted from the transmission unit 202 by serial communication (S251) and converts the received signal from the serial signal to the parallel signal (8252). Furthermore, the receiving system 102B descrambles the converted signal (S253) and analyzes a reception signal obtained as a result (S254). Here, in a case where the first notification method is used, the MC number of the damaged or lost A-packet is acquired from the error notification packet. Further, in a case where the third notification method is used, the MC number of the damaged or lost A-packet is acquired from CM+CN+MC. Then, the transmitting system 102A checks consistency between the MC number of the error packet acquired from the error notification data and the MC number of the transmission packet buffer by referring to the transmission table Tl, acquires a packet type (protocol type) of the target MC number (S255) and notifies the upper layer of the packet type (S256).

### Effects of New Scheme

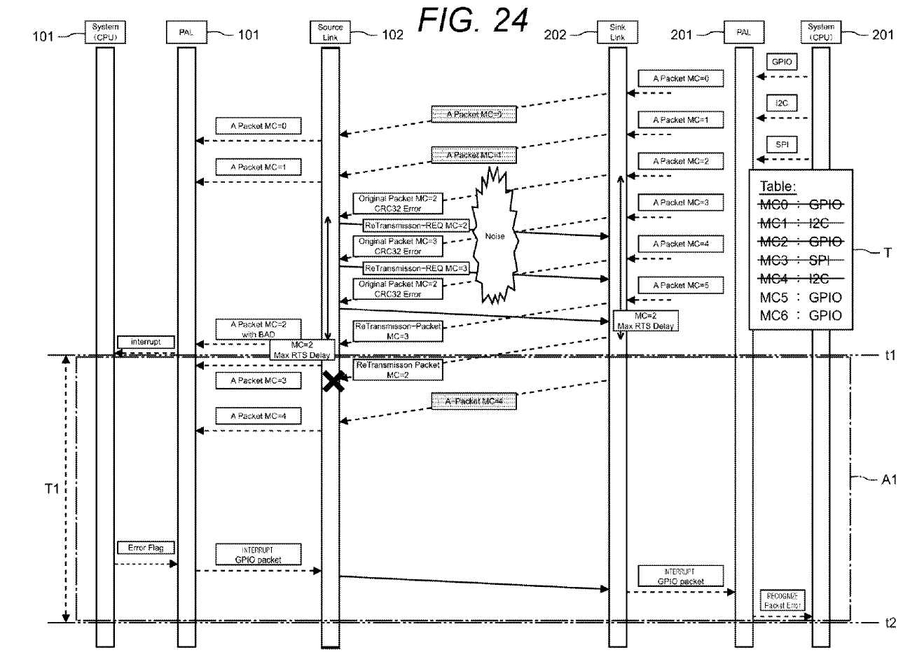

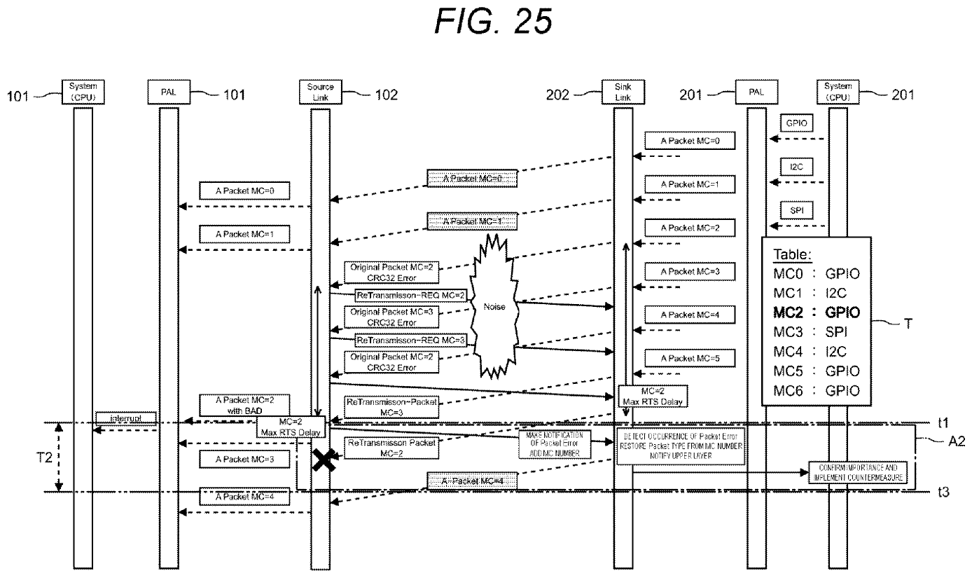

Effects obtained by adopting the new scheme will be described. Here, with reference to FIGS. 24 and 25, a case will be described where a period until the upper layer is notified can be reduced when the A-packet is damaged or lost in a case where the new scheme is adopted as compared with a case where the current scheme is adopted.

a. Case of Current Scheme

FIG. 24 is a sequence diagram indicating signals exchanged between the source side and the sink side in a case where the current scheme is used. In FIG. 24, a left part in the figure is the source side, a right part in the figure is the sink side, and a time direction is a direction from the upper side to the lower side in the figure. In a case where the source side corresponds to the transmission device 10, System (CPU) and PAL correspond to the processing unit 101, and Source Link corresponds to the transmission unit 102. In a case where the sink side corresponds to the transmission device 20, System (CPU) and PAL correspond to the processing unit 201, and Sink Link corresponds to the transmission unit 202.

In FIG. 24, on the sink side, System supplies data in various schemes such as GPIO, I2C, and SPI to PAL. PAL generates A-packets from data in various schemes (protocol types). Sink Link sequentially transmits the A-packets from PAL. In this event, MC numbers are added to the A-packets. In addition, the MC numbers and the protocol types can be managed in association with each other by the table T.

On the source side, the A-packets transmitted from the sink side are sequentially received and transmitted from Source Link to PAL. Here, a case where noise occurs in a transmission path upon serial communication is assumed. In this event, an A-packet (MC=0) and an A-packet (MC=1) are normally transmitted from the sink side to the source side, but an A-packet (MC=2) and an A-packet (MC=3) are damaged or lost due to the influence of noise. Thus, a CRC32 error is detected from the A-packets of MC=2 and 3, and a retransmission request is made. The sink side retransmits the A-packet (MC=3) and the A-packet (MC=2) in response to the retransmission request from the source side.

Upon reception of the retransmitted A-packet (MC=3), the source side does not receive the A-packet (MC=2), and a maximum delay period (MC=2 Max RTS Delay) of the A-packet (MC=2) is exceeded. Thus, the source side notifies PAL that the A-packet (MC=2) is damaged (BAD) and makes an interrupt request during the processing of System. System notifies PAL of an error flag (Error Flag) in response to the interrupt request, and Source Link notifies the sink side of the interrupt (GPIO Packet) from PAL. Then, on the sink side, an interrupt (GPIO Packet) notified from the source side is transferred from Sink Link to PAL, so that System recognizes the error in the A-packet.

As described above, in a case where the current scheme is used, the damage or the loss of the packet is determined in the upper layer and a notification is made by the packet of GPIO, or the like, and thus, it takes a lot of time to perform the processing from the source side to the sink side. In addition, in a case where the A-packet is lost, there is a case where a type of the lost A-packet cannot be determined on the source side. In particular, in the case of I2C, a timeout on the order of 100 ms occurs, and the loss of the A-packet is found. Further, the source side may not be able to recognize which A-packet among the transmitted A-packets is damaged. The source side can confirm that the A-Packet has been damaged or lost by reading DIAG_CNT, but polling of a register in ESS CCI is required, and a type of the damaged packet cannot be recognized.

b. Case of New Scheme

FIG. 25 is a sequence diagram indicating signals exchanged between the source side and the sink side in a case where the new scheme is used. In FIG. 25, in a similar manner to FIG. 24, in a case where the left part in the figure is the source side and the right part in the figure is the sink side, the A-packets transmitted from the sink side are sequentially received on the source side, but noise occurs in the transmission path, a CRC32 error is detected from the A-packets of MC=2 and 3, and a retransmission request is made. The sink side retransmits the A-packet (MC=3) and the A-packet (MC=2) in response to the retransmission request from the source side, but on the source side, a maximum delay period (MC=2 Max RTS Delay) is exceeded before receiving the retransmitted A-packet (MC=2), and thus, the source side notifies PAL that the A-packet (MC=2) is damaged (BAD) and makes an interrupt request during processing of System.

In this event, in the new scheme, Source Link on the source side notifies the sink side of the error in the A-packet by the error notification data to which the MC number is added using the notification method such as the first notification method described above, so that Sink Link can detect that the error has occurred in the transmitted A-packet on the sink side. Furthermore, by adding the MC number upon notification of the error in the A-packet, on the sink side, Sink Link can restore the type of the damaged or lost A-packet from the MC number with reference to the table T and notify the upper layer of the type of the damaged or lost A-packet. As a result, for example, System on the sink side can confirm importance of the error packet and implement a countermeasure in accordance with the importance.

As described above, in a case where the new scheme is used, the transmission unit 202 of the source can directly notify the transmission unit 102 of the sink that is the counterpart, of occurrence of the error in the A-packet, so that it is possible to shorten a processing period until the sink side is notified from the source side. In addition, the transmission unit 102 of the source makes a notification of the MC number of the A-packet in which the error has occurred, so that the transmission unit 202 of the sink that is the counterpart can recognize the packet type (protocol type) from the held table T. As a result, the system (CPU) can recognize occurrence of an error at an early stage.

More specifically, as indicated in a frame A1 indicated by a one-dot chain line in FIG. 24, on the source side, if the A-packet (MC=2) cannot be received even if the maximum delay period (MC=2 Max RTS Delay) is exceeded, Source Link notifies the upper layer that an error has occurred in the packet, thereby notifying the sink side according to an instruction from the upper layer. Thus, a period T1 is required from time t1 after the maximum delay period has elapsed on the source side to time t2 at which System recognizes the packet error on the sink side.

On the other hand, as indicated in a frame A2 indicated by a one-dot chain line in FIG. 25, if the A-packet (MC=2) cannot be received even if the maximum delay period (MC=2 Max RTS Delay) is exceeded on the source side, Source Link can directly notify Sink Link that is the counterpart that an error has occurred in the packet, using a notification method such as the first notification method described above. Thus, a period T2 is required from time t1 after the maximum delay period has elapsed on the source side to time t3 at which System recognizes the packet error on the sink side. Thus, if the period T1 in a case where the current scheme is used is compared with the period T2 in a case where the new scheme is used, it is clear that System can recognize occurrence of the error more quickly by using the new scheme.

As described above, in the present disclosure, the transmission system 1 including the transmission device 10 and the transmission device 20 connected via the A-PHY I/F defined in the MIPI standard has the following configuration. In other words, the transmission device 10 includes the transmission unit 102, and in a case where an error in the A-packet transmitted from the transmission device 20 is detected, the transmission unit 102 generates error notification data to which an MC number of an error packet that is the A-packet in which the error has been detected is added, and transmits the generated error notification data to the transmission device 20. In addition, the transmission device 20 includes the transmission unit 202, and the transmission unit 202 holds correspondence information in which the type of the transmitted A-packet is associated with the MC number of the A-packet, and in a case where the error notification data transmitted from the transmission device 10 is received, acquires a type of the A-packet corresponding to the MC number of the error packet added to the received error notification data from the held correspondence information, and restores a type of the error packet.

Here, in a case where the transmission unit 102 is the source and the transmission unit 202 is the sink, transmission of the error notification data is performed in downlink, and thus, the first notification method or the second notification method can be used, and the error notification packet or PKTERR+MC is generated as the error notification data. In this event, the correspondence information is, for example, the transmission table 12. On the other hand, in a case where the transmission unit 102 is the sink and the transmission unit 202 is the source, transmission of the error notification data is performed in uplink, and thus, the first notification method or the third notification method can be used, and the error notification packet or CM+CN+MC is generated as the error notification data. In this event, the correspondence information is, for example, the transmission table T1.

In a case where the transmission system 1 to which the present disclosure is applied has the above configuration and an error has occurred in the A-packet being transmitted, the error packet can be specified by exchanging the error notification data to which the MC number of the error packet is added between the transmission unit 102 and the transmission unit 202 that perform processing related to the A-PHY and acquiring the MC number of the error packet. In other words, determination of the processing unit 101 or the processing unit 201 that performs the processing related to the upper layer is unnecessary, so that it is possible to recognize occurrence of an error at an early stage and perform the processing. As described above, in the transmission system 1 to which the present disclosure is applied, in a case where an error has occurred in a packet, a notification of the packet error can be made more appropriately.

### Modifications

In the above description, three notification methods have been described as the new scheme, but each of the first notification method, the second notification method, and the third notification method may be performed not only independently but also simultaneously by combining a plurality of notification methods. For example, in downlink, the first notification method and the second notification method may be combined to generate and transmit both the error notification packet and PKTERR+MC. In uplink, the first notification method and the third notification method may be combined to generate and transmit both the error notification packet and CM+CN+MC. Note that the transmission table T1 and the transmission table T2 can be recorded and held in a storage device such as a random access memory (RAM) included in the transmission unit 102 and the transmission unit 202. Note that the damaged/lost flag may indicate at least one of the damaged packet or the lost packet.

Note that the embodiment of the present disclosure is not limited to the above-described embodiment, and various modifications can be made without departing from the gist of the present disclosure. Furthermore, the effects described in the present specification are merely examples and are not restrictive, and some other effects may be achieved.

Furthermore, the present disclosure may have the following configurations.
(1) A transmission system including a first transmission device and a second transmission device connected via an A-PHY I/F defined in an MIPI standard, in which
the first transmission device includes
a first transmission unit that,
in a case where an error in an A-packet transmitted from the second transmission device is detected, generates error notification data to which an MC number of an error packet that is the A-packet in which the error has been detected is added, and
transmits the generated error notification data to the second transmission device,
the second transmission device includes
a second transmission unit that
holds correspondence information in which a type of the transmitted A-packet is associated with an MC number of the A-packet, and
in a case where the error notification data transmitted from the first transmission device is received, acquires from the held correspondence information a type of the A-packet corresponding to the MC number of the error packet added to the received error notification data and restores a type of the error packet, and
the first transmission unit and the second transmission unit perform processing related to A-PHY.
(2) The transmission system according to (1), in which
the error notification data is an error notification packet including an A-packet, and
the error notification packet includes the MC number in a payload.
(3) The transmission system according to (2), in which
the payload further includes a flag indicating damage or loss of the error packet.
(4) The transmission system according to (2) or (3), in which
the error notification packet is a packet defined by a Link service or a PHY service defined in the MIPI standard.
(5) The transmission system according to (1), in which
the error notification data is a code indicating a packet error and the MC number added to the code, and
the code includes a combination of Idle and ISS different from EOI.
(6) The transmission system according to (5), in which
a flag indicating damage or loss of the error packet is further added to the code.
(7) The transmission system according to (1), in which
the error notification data includes CM and CN that are consecutively transmitted, and the MC number added to the CM and the CN that are consecutive, and
the CN includes a code indicating an error in the A-packet.
(8) The transmission system according to (7), in which
a flag indicating damage or loss of the error packet is further added to the CM and the CN that are consecutive.
(9) The transmission system according to any one of (1) to (8), in which
the correspondence information is a table that is held until a certain period elapses from transmission of the A-packet.
(10) A transmission device including:
a transmission unit that
receives an A-packet transmitted from another transmission device connected via an A-PHY I/F defined in an MIPI standard,
in a case where an error in the A-packet is detected, generates error notification data to which an MC number of an error packet that is the A-packet in which the error has been detected is added, and
transmits the generated error notification data to the another transmission device, in which
the transmission unit performs processing related to A-PHY.
(11) The transmission device according to (10), in which
the error notification data is an error notification packet including an A-packet, and
the error notification packet includes the MC number in a payload.
(12) The transmission device according to (10), in which
the error notification data is a code indicating a packet error and the MC number added to the code, and
the code includes a combination of Idle and ISS different from EOI.
(13) The transmission device according to (10), in which
the error notification data includes CM and CN that are consecutively transmitted, and the MC number added to the CM and the CN that are consecutive, and
the CN includes a code indicating an error in the A-packet.
(14) A transmission method of a transmission device including a transmission unit that performs processing related to A-PHY defined in an MIPI standard, the transmission method including:
by the transmission unit
receiving an A-packet transmitted from another transmission device connected via an A-PHY I/F;
in a case where an error in the A-packet is detected, generating error notification data to which an MC number of an error packet that is the A-packet in which the error has been detected is added; and
transmitting the generated error notification data to the another transmission device by the transmission unit.
(15) A transmission device including:
a transmission unit that
transmits an A-packet to another transmission device connected via an A-PHY I/F defined in an MIPI standard,
holds correspondence information in which a type of the transmitted A-packet is associated with an MC number of the A-packet,
in a case where error notification data transmitted from the another transmission device is received, acquires a type of the A-packet corresponding to an MC number of an error packet added to the received error notification data from the held correspondence information, and restores a type of the A-packet in which an error has been detected as the error packet, in which
the transmission unit performs processing related to A-PHY.
(16) The transmission device according to (15), in which
the error notification data is an error notification packet including an A-packet, and
the error notification packet includes the MC number in a payload.
(17) The transmission device according to (15), in which
the error notification data is a code indicating a packet error and the MC number added to the code, and
the code includes a combination of Idle and ISS different from EOI.
(18) The transmission device according to (15), in which
the error notification data includes CM and CN that are consecutively transmitted, and the MC number added to the CM and the CN that are consecutive, and
the CN includes a code indicating an error in the A-packet.
(19) A transmission method of a transmission device including a transmission unit that performs processing related to A-PHY defined in an MIPI standard, the transmission method including:
by the transmission unit.
transmitting an A-packet to another transmission device connected via an A-PHY I/F;
holding correspondence information in which a type of the transmitted A-packet is associated with an MC number of the A-packet; and
in a case where error notification data transmitted from the another transmission device is received, acquiring a type of the A-packet corresponding to an MC number of an error packet added to the received error notification data from the held correspondence information, and
restoring a type of the A-packet in which an error has been detected as the error packet.

### REFERENCE SIGNS LIST

1 Transmission system
10 Transmission device
20 Transmission device
30 Transmission path
101 Processing unit
102 Transmission unit
102A Transmitting system
1023 Receiving system
111 RTS
112 Scrambler
113 Decoder
114 Descrambler
115 Stream controller
116 RTS
117 Packet generation unit
201 Processing unit
202 Transmission unit
202A Transmitting system
202B Receiving system
211 RTS
212 Stream controller
213 Scrambler
214 Encoder
215 Descrambler
216 RTS
217 Packet generation unit

1. A transmission system comprising a first transmission device and a second transmission device connected via an A-PHY I/F defined in an MIPI standard, wherein
the first transmission device includes
a first transmission unit that,
in a case where an error in an A-packet transmitted from the second transmission device is detected, generates error notification data to which an MC number of an error packet that is the A-packet in which the error has been detected is added, and
transmits the generated error notification data to the second transmission device,
the second transmission device includes
a second transmission unit that
holds correspondence information in which a type of the transmitted A-packet is associated with an MC number of the A-packet, and
in a case where the error notification data transmitted from the first transmission device is received, acquires from the held correspondence information a type of the A-packet corresponding to the MC number of the error packet added to the received error notification data and restores a type of the error packet, and
the first transmission unit and the second transmission unit perform processing related to A-PHY.

2. The transmission system according to claim 1, wherein
the error notification data is an error notification packet including an A-packet, and
the error notification packet includes the MC number in a payload.

3. The transmission system according to claim 2, wherein
the payload further includes a flag indicating damage or loss of the error packet.

4. The transmission system according to claim 2, wherein
the error notification packet is a packet defined by a Link service or a PHY service defined in the MIPI standard.

5. The transmission system according to claim 1, wherein
the error notification data is a code indicating a packet error and the MC number added to the code, and
the code includes a combination of Idle and ISS different from EOI.

6. The transmission system according to claim 5, wherein
a flag indicating damage or loss of the error packet is further added to the code.

7. The transmission system according to claim 1, wherein
the error notification data includes CM and CN which are consecutively transmitted, and the MC number added to the CM and the CN which are consecutive, and
the CN includes a code indicating an error in the A-packet.

8. The transmission system according to claim 7, wherein
a flag indicating damage or loss of the error packet is further added to the CM and the CN that are consecutive.

9. The transmission system according to claim 1, wherein
the correspondence information is a table that is held until a certain period elapses from transmission of the A-packet.

10. A transmission device comprising:
a transmission unit that
receives an A-packet transmitted from another transmission device connected via an A-PHY I/F defined in an MIPI standard,
in a case where an error in the A-packet is detected, generates error notification data to which an MC number of an error packet that is the A-packet in which the error has been detected is added, and
transmits the generated error notification data to the another transmission device, wherein
the transmission unit performs processing related to A-PHY.

11. The transmission device according to claim 10, wherein
the error notification data is an error notification packet including an A-packet, and
the error notification packet includes the MC number in a payload.

12. The transmission device according to claim 10, wherein
the error notification data is a code indicating a packet error and the MC number added to the code, and
the code includes a combination of Idle and ISS different from EOI.

13. The transmission device according to claim 10, wherein
the error notification data includes CM and CN that are consecutively transmitted, and the MC number added to the CM and the CN that are consecutive, and
the CN includes a code indicating an error in the A-packet.

14. A transmission method of a transmission device including a transmission unit that performs processing related to A-PHY defined in an MIPI standard, the transmission method comprising:
by the transmission unit,
receiving an A-packet transmitted from another transmission device connected via an A-PHY I/F;
in a case where an error in the A-packet is detected, generating error notification data to which an MC number of an error packet that is the A-packet in which the error has been detected is added; and
transmitting the generated error notification data to the another transmission device.

15. A transmission device comprising:
a transmission unit that
transmits an A-packet to another transmission device connected via an A-PHY I/F defined in an MIPI standard,
holds correspondence information in which a type of the transmitted A-packet is associated with an MC number of the A-packet,
in a case where error notification data transmitted from the another transmission device is received, acquires a type of the A-packet corresponding to an MC number of an error packet added to the received error notification data from the held correspondence information, and restores a type of the A-packet in which an error has been detected as the error packet, wherein
the transmission unit performs processing related to A-PHY.

16. The transmission device according to claim 15, wherein
the error notification data is an error notification packet including an A-packet, and
the error notification packet includes the MC number in a payload.

17. The transmission device according to claim 15, wherein
the error notification data is a code indicating a packet error and the MC number added to the code, and
the code includes a combination of Idle and ISS different from EOI.

18. The transmission device according to claim 15, wherein
the error notification data includes CM and CN that are consecutively transmitted, and the MC number added to the CM and the CN that are consecutive, and
the CN includes a code indicating an error in the A-packet.

19. A transmission method of a transmission device including a transmission unit that performs processing related to A-PHY defined in an MIPI standard, the transmission method comprising:
by the transmission unit,
transmitting an A-packet to another transmission device connected via an A-PHY I/F;
holding correspondence information in which a type of the transmitted A-packet is associated with an MC number of the A-packet; and
in a case where error notification data transmitted from the another transmission device is received, acquiring a type of the A-packet corresponding to an MC number of an error packet added to the received error notification data from the held correspondence information, and restoring a type of the A-packet in which an error has been detected as the error packet.
